(19) United States
(12) Patent Application Publication
(10) Pub. No.: US 2013/0154540 A1
(43) Pub. Date: Jun. 20, 2013

(54) MOTOR CONTROLLING CIRCUIT, MOTOR DRIVING DEVICE, AND MOTOR CONTROLLING METHOD

(71) Applicant: Bon Young KOO, Suwon (KR)

(72) Inventor: Bon Young KOO, Suwon (KR)

(73) Assignee: SAMSUNG ELECTRO-MECHANICS CO., LTD.

(21) Appl. No.: 13/404,808

(22) Filed: Feb. 24, 2012

(30) Foreign Application Priority Data
Dec. 14, 2011 (KR) 10-2011-0134252

(51) Int. Cl. H02P 6/06

(52) U.S. Cl. 318/721

(57) ABSTRACT

There are provided a motor controlling circuit, a motor driving device, and a motor controlling method. The motor controlling circuit includes: a frequency detecting unit detecting a frequency of an internal clock signal of a motor driving circuit; a sampling unit sampling an input pulse width modulation (PWM) signal using the frequency of the internal clock signal; and a calculating unit sensing a change in a speed of the internal clock signal from a sampling result of the sampling unit and calculating a revolution per minute (RPM) of a motor from the sensed change in the speed.

### CROSS-REFERENCE TO RELATED APPLICATIONS

This application claims the priority of Korean Patent Application No. 10-2011-0134252 filed on Dec. 14, 2011, in the Korean Intellectual Property Office, the disclosure of which is incorporated herein by reference.

### BACKGROUND OF THE INVENTION

1. Field of the Invention

The present invention relates to a motor controlling circuit, a motor driving device, and a motor controlling method capable of accurately detecting a revolution per minute (RPM), a rotation speed, or the like, of a motor, regardless of a change in an internal temperature, or the like, thereof.

2. Description of the Related Art

Generally, the speed of a motor, such as a brushless direct current (BLDC) motor, whose speed is capable of being controlled, may be controlled through adjusting a duty value of a pulse width modulation (PWM) signal. The duty value of the PWM signal may be determined according to a section between a turn-on time, in which the signal has a high value in one period thereof, and a turn-off time, in which the signal has a low value in one period thereof, and the rotation speed of the motor may be in proportion to the duty value of the PWM signal.

Motor speed controlling schemes may be largely divided into an open loop control scheme and a closed loop control scheme. The open loop control scheme does not require a feedback circuit, such that it may be implemented using a simple structure; however, it may not compensate for an error generated due to an external factor such as electrical noise, a temperature change, or the like. On the other hand, in the case of the closed loop control scheme, a feedback circuit is included, such that a current RPM, a speed, a surrounding operational environment, and the like, of a motor, are detected and an input signal is controlled with reference to the detection results, whereby an error generated in an operation of the motor may be controlled.

As a result, in the case of the closed loop control scheme, a circuit for detecting current RPM, a speed, and the like, of the motor, is required, and a temperature detecting circuit, a voltage detecting circuit, and the like, may also be added. Therefore, complicity of the circuit increases, and an effect due to a surrounding operational environment may not accurately reflected in detecting the RPM and speed of the motor in the case in which the temperature detecting circuit, the voltage detecting circuit, and the like, are excluded from a circuit configuration.

### SUMMARY OF THE INVENTION

An aspect of the present invention provides a motor controlling circuit, a motor driving device, and a motor controlling method in which an input pulse width modulation signal is sampled using a frequency of an internal clock signal of a motor driving circuit and a change in a speed of the internal clock signal is sensed from the sampled result to control a speed of a motor, such that an operation of the motor may be accurately controlled through a reflection of a surrounding environment effect without a separate temperature or voltage detection circuit.

According to an aspect of the present invention, there is provided a motor controlling circuit including: a frequency detecting unit detecting a frequency of an internal clock signal of a motor driving circuit; a sampling unit sampling an input pulse width modulation (PWM) signal using the frequency of the internal clock signal; and a calculating unit sensing a change in a speed of the internal clock signal from a sampling result of the sampling unit and calculating a revolution per minute (RPM) of a motor from the sensed change in the speed.

The sampling unit may calculate a sampling number of the input PWM signal during one period using the frequency of the internal clock signal.

The calculating unit may determine that the speed of the internal clock signal has decreased when the sampling number of the input PWM signal during one period decreases, while determining that the speed of the internal clock signal has increased when the sampling number of the input PWM signal during one period increases

The motor controlling circuit may further include a speed controlling unit controlling a rotation speed of the motor from the RPM of the motor, calculated by the calculating unit.

According to another aspect of the present invention, there is provided a motor driving device including: a frequency detecting unit detecting a frequency of an input PWM signal; a comparing unit detecting a driving RPM of a motor and comparing the detected driving RPM of the motor with an RPM according to a duty value of the input PWM signal; and a signal generating unit generating a driving signal for the motor, based on a comparison result of the comparing unit, wherein the comparing unit detects the driving RPM of the motor using the frequency of the input PWM signal.

The comparing unit may detect the driving RPM of the motor by sampling one period of a clock signal for driving the motor using the frequency of the input PWM signal.

According to another aspect of the present invention, there is provided a motor controlling method including: detecting a frequency of an internal clock signal of a motor driving circuit; sampling an input PWM signal using the frequency of the internal clock signal; sensing a change in a speed of the internal clock signal from a sampling result for the input PWM signal; and calculating an RPM of a motor from the sensed change in the speed.

In the sampling of the input PWM signal, a sampling number of the input PWM signal during one period may be counted based on the frequency of the internal clock signal.

In the sensing of the change in the speed, it may be determined that the speed of the internal clock signal has decreased when a sampling number of the input PWM signal during one period decreases, while it may be determined that the speed of the internal clock signal has increased when the sampling number of the input PWM signal during one period increases.

The motor controlling method may further include controlling a rotation speed of the motor from the sensed change in the speed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram schematically showing a motor controlling circuit according to an embodiment of the present invention;

FIGS. 2 and 3 are block diagrams schematically showing a motor driving device according to the embodiment of the present invention;

FIG. 4 is a graph provided in order to describe a motor driving method according to the embodiment of the present invention; and

FIGS. 5 and 6 are flow charts provided in order to describe a motor driving method according to the embodiment of the present invention.

### DETAILED DESCRIPTION OF THE INVENTION

Embodiments of the present invention will be described in detail with reference to the accompanying drawings These embodiments will be described in detail for those skilled in the art in order to practice the present invention. It should be appreciated that various embodiments of the present invention are different but do not have to be exclusive. For example, specific shapes, configurations, and characteristics described in an embodiment of the present invention may be implemented in another embodiment without departing from the spirit and the scope of the present invention. In addition, it should be understood that position and arrangement of individual components in each disclosed embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawing.

Hereinafter, embodiments of the present invention will be described in detail with reference to the accompanying drawings so that those skilled in the art may easily practice the present invention.

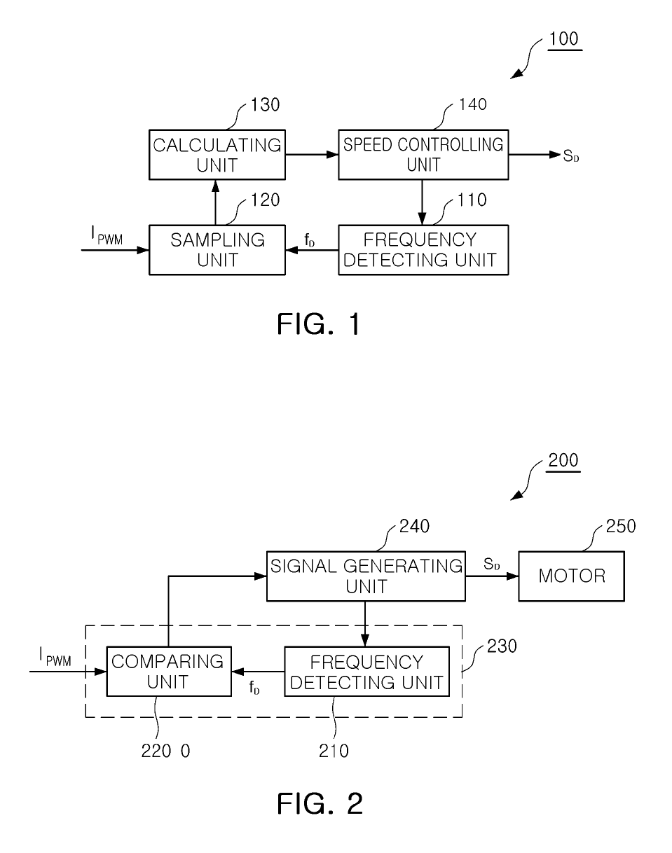

FIG. 1 is a block diagram schematically showing a motor controlling circuit according to an embodiment of the present invention. Referring to FIG. 1, a motor controlling circuit 100 according to the embodiment of the present invention may include a frequency detecting unit 110, a sampling unit 120, a calculating unit 130, and a speed controlling unit 140. An operation of a motor may be controlled according to a signal output from the speed controlling unit 140. For example, the controlling unit 140 may control a rotation speed, or the like, of the motor by adjusting a duty value of a pulse width modulation (PWM) signal.

The frequency detecting unit 110 and the sampling part 120 may be connected to the speed controlling unit 140 and the calculating unit 130, respectively, to thereby configure a feedback circuit. The frequency detecting unit 110 receives a driving signal S_{D} output from the speed controlling unit 140 to the motor or a parameter used to generate the driving signal S_{D} to thereby detect a frequency f_{D} of the driving signal S_{D} output to the motor. Since the detected frequency f_{D} is the frequency f_{D} of the driving signal S_{D} for driving the motor, it may be changed due to a change in an external environment such as a temperature change, or the like. As described below, a driving speed of the motor may be accurately detected from the frequency f_{D} of the driving signal S_{D} changed according to the change in the external environment. For example, the frequency f_{D} may be detected from the driving signal S_{D} provided in the form of a clock signal.

The sampling unit 120 may sample an input pulse width modulation signal I_{PWM} using the frequency f_{D} of the driving signal S_{D} detected by the frequency detecting unit 110. The input pulse width modulation signal I_{PWM} may be a signal generated and input from the outside of the motor controlling circuit 100. Therefore, the input pulse width modulation signal I_{PWM} is generated independently of a driving environment of the motor, such that it is not affected by the change in the external environment such as the temperature change, or the like. Therefore, when it is assumed that the input pulse width modulation signal I_{PWM} has a predetermined period and duty value, the sampling result output from the sampling unit 120 to the calculating unit 130 may be determined based on the frequency f_{D} detected by the frequency detecting unit 110.

For example, assumed that a sampling number of the input pulse width modulation signal I_{PWM} when the input pulse width modulation signal I_{PWM} is sampled by the frequency f_{D} is 10 in a predetermined time section t1 in which the motor is driven and the sampling number of the input pulse width modulation signal I_{PWM} when the input pulse width modulation signal I_{PWM} is sampled by the frequency f_{D} decreases to 7 in another time section t2, the frequency D is relatively decreased in the time section t2 as compared to in the time section t1, which means that an internal clock speed decreases. Therefore, if the sampling number of the input pulse width modulation signal I_{PWM} when the input pulse width modulation signal I_{PWM} is sampled by the frequency f_{D} decreases, it may be recognized that the internal clock speed decreases. If the sampling number of the input pulse width modulation signal I_{PWM} when the input pulse width modulation signal I_{PWM} is sampled by the frequency f_{D} increases, it may be recognized that the internal clock speed increases.

A change in the internal clock speed sensed by the above-mentioned scheme may be reflected to accurately sense a speed of the motor. That is, when it is recognized that the internal clock speed decreases by 10%, an actual speed of the motor may be detected by decreasing a motor speed detected by a speed detecting unit (not shown) detecting the motor speed from the RPM of the motor by 10%. Conversely, when it is recognized that the internal clock speed increases by 10%, the actual speed of the motor may be detected by increasing the motor speed detected from the RPM of the motor by 10%.

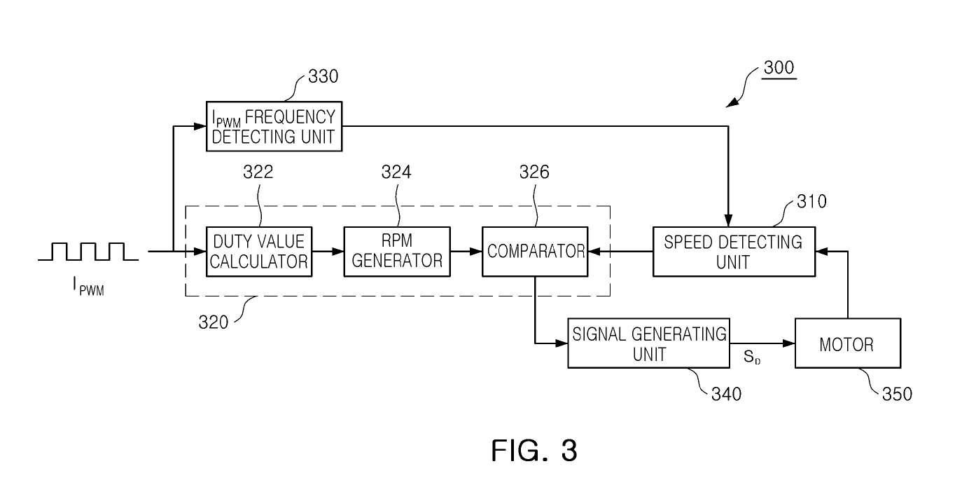

FIG. 2 is a block diagram schematically showing a motor driving device according to the embodiment of the present invention. Referring to FIG. 2, the motor driving device 200 according to the embodiment may include a frequency detecting unit 210, a comparing unit 220, a signal generating unit 240, and a motor 250. The frequency detecting unit 210 and the comparing unit 220 may configure a feedback circuit, and the motor 250 receiving the driving signal S_{D} from the signal generating unit 240 to perform an operation may be a brushless direct current (BLDC) motor.

Similar to FIG. 1, the comparing unit 220 receives the input pulse width modulation signal I_{PWM} and the frequency f_{D} detected by the frequency detecting unit 210 from the signal generating unit 240 and samples the input pulse width modulation signal I_{PWM} using the detected frequency f_{D}. The frequency detecting unit 210 may detect the frequency f_{D} from a parameter internally adjusted in order to determine the driving signal S_{D} transferred to the motor 250 by the signal generating unit 240 or detect the frequency f_{D} directly from the driving signal S_{D} output from the signal generating unit 240. That is, since the frequency f_{D} detected by the frequency detecting unit 210 is determined by the driving signal S_{D} of the motor 250, it may be changed according to a driving environment of the motor 250.

The comparing unit 220 may sample the input pulse width modulation signal I_{PWM} using the frequency f_{D} detected by the frequency detecting unit 210. The input pulse width modulation signal I_{PWM}, a signal generated and supplied from the outside of the motor driving device 200, independently from the driving environment of the motor 250, has a predetermined period and duty value. Therefore, the sampling result generated and output by the comparing unit 220 may be determined based on the frequency f_{D} detected by the frequency detecting unit 210. Therefore, it can be seen that a variation in the sampling result output by the comparing unit 220 may correspond to a variation in the frequency f_{D} detected by the frequency detecting unit 210 from the signal generating unit 240. The signal generating unit 240 may sense a change in a speed of the driving signal S_{D} supplied to the motor 250 from the variation in sampling result.

FIG. 3 is a block diagram schematically showing a motor driving device according to the embodiment of the present invention. Referring to FIG. 3, a motor driving device 300 according to the embodiment may include a speed detecting unit 310 detecting a speed of a motor 350, a comparing unit 320, an input pulse width modulation signal I_{PWM} frequency detecting unit 330, a signal generating unit 340, and the like. As described above with reference to FIGS. 1 and 2, the input pulse width modulation signal I_{PWM}, which is a signal generated from the outside, independently from the motor driving device 300, may have a predetermined period, a predetermined duty value, and the like, independently from a driving environment of the motor 350. In addition, the motor 350 may be a BLDC motor.

The speed detecting unit 310 may detect a driving speed of the motor 350 from an RPM of the motor 350. Since the driving speed of the motor 350 needs to be maintained as a value designated by a user, the overall operation of the motor driving device 300 may be performed such that the driving speed of the motor 350 is detected and the driving speed of the motor 350 is decreased by adjusting the driving signal S_{D} output from the signal generating unit 340 to the motor 350 when the detected driving speed is higher than the value designated by the user, while the driving speed of the motor 350 is increased when the detected driving speed is lower than the value designated by the user.

The speed detecting unit 310 may use the input pulse width modulation signal I_{PWM} in order to detect the driving speed of the motor 350. That is, the driving signal S_{D} for operating the motor 350 may be sampled using a frequency detected by the input pulse width modulation signal I_{PWM} frequency detecting unit 330, and the driving speed of the motor 350 may be detected from the sampling result. The sampling method and speed detecting method as described with reference to FIGS. 1 and 2 may be used.

Apart from the input pulse width modulation signal I_{PWM} supplied from the outside, the driving signal S_{D} supplied from the signal generating unit 340 to the motor 350 may also be generated in the form of a pulse width modulation signal. In this case, the driving speed of the motor 350 may be determined by a duty value of the driving signal S_{D}. That is, when the duty value of the driving signal S_{D} increases, the driving speed of the motor 350 increases, while when the duty value of the driving signal S_{D} decreases, the driving speed of the motor 350 decreases.

In the case in which the driving signal S_{D} supplied to the motor 350 is in the form of the pulse width modulation signal, a method of detecting the driving speed of the motor 350, performed by the speed detecting unit 310 may also be based on the duty value of the driving signal S_{D}. That is, since the duty value is determined by a ratio of an interval between a timing in which the driving signal S_{D} is turned and has a high value and a timing in which the driving signal S_{D} is turned off and has a low value, the driving speed of the driving signal S_{D} may be detected by calculating the duty value of the driving signal S_{D} using a period of the driving signal S_{D} and the timing in which the driving signal S_{D} has the high value and converting the duty value into a driving RPM of the motor 350.

The comparing unit 320 may include a duty value calculator 322, an RPM generator 324, and a comparator 326. Similar to the cases of FIGS. 1 and 2, the comparing unit 320 may receive the input pulse width modulation signal I_{PWM} and calculate a duty value of the input pulse width modulation signal I_{PWM} in the duty value calculator 322. The duty value calculator 322 may calculate the duty value of the input pulse width modulation signal I_{PWM} from a period of the input pulse width modulation signal I_{PWM} and a timing in which the input pulse width modulation signal I_{PWM} has a high value, similar to the speed detecting unit 310.

The RPM generator 324 may generate the RPM of the motor 350 corresponding to the duty value of the input pulse width modulation signal I_{PWM}. The RPM generator 324 may read the RPM of the motor 350 corresponding to the duty value of the input pulse width modulation signal I_{PWM} with reference to a relationship between the duty value of the input pulse width modulation signal I_{PWM} previously prepared as data or the like, and the RPM of the motor 350, or may generate the RPM of the motor 350 according to the duty value of the input pulse width modulation signal I_{PWM} by directly performing calculation according to a specific formula.

The comparator 326 may compare the RPM of the motor 350 generated by the RPM generator 324 with the RPM of the motor 350 directly detected by the speed detecting unit 310 and transmit the comparison result to the signal generating unit 340. When both of the speed detecting unit 310 and the RPM generator 324 transfer data in an RPM format of the motor 350, the comparator 326 may compare data and transfer information on whether the RPM of the motor 350 detected by the speed detecting unit 310 is greater than the RPM of the motor 350 generated by the RPM generator 324, to the signal generating unit 340. The signal generating unit 340 may determine whether to increase or decrease the speed of the motor 350 from the comparison result of the comparator 326, thereby adjusting the driving signal S_{D}.

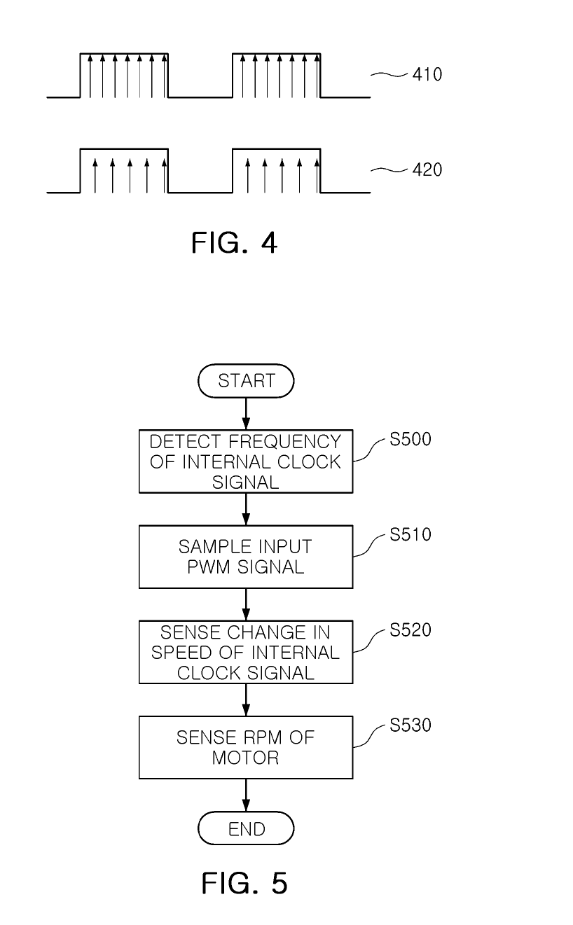

FIG. 4 is a graph provided in order to describe a motor driving method according to the embodiment of the present invention. In FIG. 4, first and second waveforms 410 and 420 are provided in order to describe a process of sampling the input pulse width modulation signal I_{PWM} having the same period and duty value through using different frequencies.

Referring to the first waveform 410, the input pulse width modulation signal I_{PWM} is sampled using a first frequency. More specifically, the input pulse width modulation signal I_{PWM} is sampled total seven times using the first frequency during a turn-on time thereof. On the other hand, in the case of the second waveform 420, the input pulse width modulation signal I_{PWM} is sampled using a second frequency. More specifically, the input pulse width modulation signal I_{PWM} is sampled total five times using the second frequency during the turn-on time thereof.

As described above, in the motor controlling circuit 100 or the motor driving devices 200 and 300 according to the embodiment of the present invention, the input pulse width modulation signal I_{PWM} may be a signal determined regardless of the driving environments of the motors 250 and 350. Therefore, even in the case in which the driving environments of the motor 250 and 350 are changed, the input pulse width modulation signal I_{PWM} may have a predetermined period and duty value regardless of the driving environments of the motors 250 and 350. On the other hand, since the frequency f_{D} used to sample the input pulse width modulation signal I_{PWM} may be detected from the signal generating units 240 and 340 generating the driving signal S_{D} for the motors 250 and 350, it may be changed according to the driving environments of the motors 250 and 350.

As a result, the input pulse width modulation signal I_{PWM} having a predetermined period and duty value is sampled using the frequency f_{D} determined according to the driving environments of the motors 250 and 350, whereby the RPM and the speed of the motors 250 and 350 may be accurately detected. As shown in FIG. 4, when the sampling number of the input pulse width modulation signal I_{PWM} decreases, it is determined that the RPM of the motors 250 and 350 has increased than an actual instruction speed due to an environmental factor, or the like, while when the sampling number increases, it is determined that the RPM of the motors 250 and 350 has increased than an actual instruction speed.

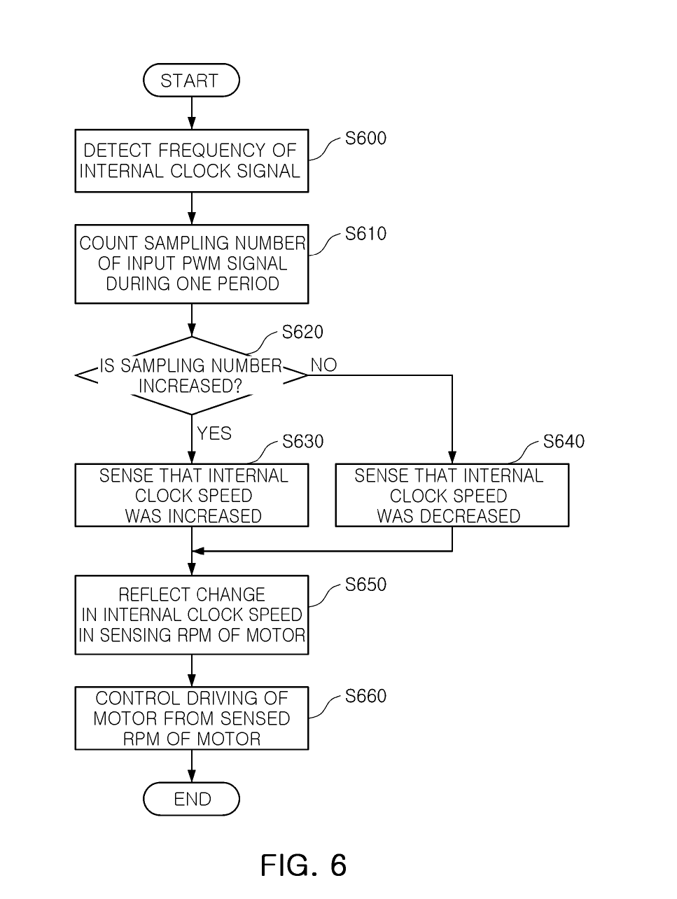

FIGS. 5 and 6 are flow charts provided in order to describe a motor driving method according to the embodiment of the present invention. Hereinafter, the flow chart of FIG. 5 will be described with reference to the embodiment of FIG. 1. However, the flow chart of FIG. 5 may also be applied to embodiments other than that of FIG. 1.

Referring to FIG. 5, in the motor driving method according to the embodiment of the present invention, first, a frequency of an internal clock signal may be detected (S500). The internal clock signal may be the driving signal S_{D} supplied from the speed controlling unit 140 in order to drive the motor, and the frequency f_{D} of the driving signal S_{D} may be detected in the frequency detecting unit 110.

After the frequency f_{D} of the internal clock signal is detected, the input pulse width modulation signal I_{PWM} may be sampled (S510). For example, the sampling unit 120 may receive the input pulse width modulation signal I_{PWM} and sample the input pulse width modulation signal I_{PWM} using the frequency f_{D} of the internal clock signal detected by the frequency detecting unit 110.

From the sampling result of operation S510, a change in a speed of the internal clock signal for driving the motor may be sensed (S520). The calculating unit 130 determines that the driving speed of the motor was increased when the sampling number of the input pulse width modulation signal I_{PWM} during the turn-on time thereof increases, while determining that the driving speed of the motor was decreased when the sampling number of the input pulse width modulation signal I_{PWM} during the turn-off time thereof decreases, using the sampling result.

From the change in the speed sensed in operation S520, the RPM of the motor is sensed (S530). As described above, when it is recognized that the sampling number decreases by 5%, the actual RPM of the motor may be sensed by decreasing a theoretical RPM calculated from the driving signal S_{D} actually supplied to the motor by 5%. To the contrary, when it is recognized that the sampling number increases by 5%, the actual RPM of the motor may be sensed by increasing a theoretical RPM calculated from the driving signal S_{D} actually supplied to the motor by 5%. The actual RPM of the motor sensed as described above may be used to generate the driving signal S_{D} in order that the motor is actually operated according to an operation condition of the motor designated by the user.

FIG. 6 is a flow chart provided in order to describe a motor driving method according to the embodiment of the present invention. Hereinafter, the flow chart of FIG. 6 will be described with reference to the embodiment of FIG. 2. However, the flow chart of FIG. 6 may also be applied to embodiments other than that of FIG. 2.

Referring to FIG. 6, in the motor driving method according to the embodiment of the embodiment, first, a frequency of an internal clock signal may be detected (S600). Similar to the case of FIG. 5, the internal clock signal may be the driving signal S_{D} supplied from the signal generating unit 240 in order to drive the motor, and the frequency f_{D} of the driving signal S_{D} may be detected in the frequency detecting unit 210 of the feedback circuit 230.

After the frequency f_{D} is detected, the sampling number of the input pulse width modulation signal I_{PWM} during one period thereof is counted (S610). As shown in the graph of FIG. 4, the comparing unit 220 may sample the input pulse width modulation signal I_{PWM} using the frequency f_{D} during the time in which the input pulse width modulation signal I_{PWM} is turned on and may count the sampling number of the input pulse width modulation signal I_{PWM}. After the sampling and the counting of the sampling number are completed, it is determined that whether the counted sampling number is increased (S620). Operation S620 of determining whether the sampling number is increased may be performed by comparing a previous period and a current period to determine whether the sampling number is increased in the current period as compared to in the previous period.

When it is determined that the sampling number was increased as a result of the determination of operation S620, the signal generating unit 240 receives the determination result from the comparing unit 220 to sense that the internal clock speed, that is, the speed of the driving signal S_{D} was increased (S630). To the contrary, when it is determined that the sampling number was decreased, the signal generating unit 240 senses that the internal clock speed was increased (S640).

In the signal generating unit 240, a change in the internal clock speed, that is, the speed of the driving signal S_{D} sensed in operation S630 or S640 may be reflected in sensing the RPM of the motor 250 (S650) and the driving of the motor 250 may be controlled from the sensed RPM of the motor (S660). Since the change in the speed of the driving signal S_{D} may be directly associated with a change in the RPM of the motor 250, the signal generating unit 240 may recognize that the RPM of the motor 250 was increased or decreased by a ratio by which the speed of the driving signal S_{D} is increased or decreased and control the driving signal S_{D} output to the motor 250, whereby a method of controlling the motor 250 in consideration of a change in an external environment such as a temperature change may be implemented.

As set forth above, according to the embodiments of the present invention, the pulse width modulation signal transferred from the outside is sampled using the frequency of the internal clock signal of the motor driving circuit, the speed of the motor is controlled based on the sampling result. Therefore, the change in the speed according to the driving environment of the motor is detected without separate temperature and voltage detecting circuits, whereby the speed of the motor can be efficiently and accurately controlled.

While the present invention has been shown and described in connection with the embodiments, it will be apparent to those skilled in the art that modifications and variations can be made without departing from the spirit and scope of the invention as defined by the appended claims.

What is claimed is:

1. A motor controlling circuit comprising:
a frequency detecting unit detecting a frequency of an internal clock signal of a motor driving circuit;
a sampling unit sampling an input pulse width modulation (PWM) signal using the frequency of the internal clock signal; and
a calculating unit sensing a change in a speed of the internal clock signal from a sampling result of the sampling unit and calculating a revolution per minute (RPM) of a motor from the sensed change in the speed.

2. The motor controlling circuit of claim 1, wherein the sampling unit calculates a sampling number of the input PWM signal during one period using the frequency of the internal clock signal.

3. The motor controlling circuit of claim 2, wherein the calculating unit determines that the speed of the internal clock signal has decreased when the sampling number of the input PWM signal during one period decreases, while determining that the speed of the internal clock signal has increased when the sampling number of the input PWM signal during one period increases.

4. The motor controlling circuit of claim 1, further comprising a speed controlling unit controlling a rotation speed of the motor from the RPM of the motor, calculated by the calculating unit.

5. A motor driving device comprising:
a frequency detecting unit detecting a frequency of an input PWM signal;
a comparing unit detecting a driving RPM of a motor and comparing the detected driving RPM of the motor with an RPM according to a duty value of the input PWM signal; and
a signal generating unit generating a driving signal for the motor, based on a comparison result of the comparing unit,
wherein the comparing unit detects the driving RPM of the motor using the frequency of the input PWM signal.

6. The motor driving circuit of claim 5, wherein the comparing unit detects the driving RPM of the motor by sampling one period of a clock signal for driving the motor using the frequency of the input PWM signal.

7. A motor controlling method comprising:
detecting a frequency of an internal clock signal of a motor driving circuit;
sampling an input PWM signal using the frequency of the internal clock signal;
sensing a change in a speed of the internal clock signal from a sampling result for the input PWM signal; and
calculating an RPM of a motor from the sensed change in the speed.

8. The motor controlling method of claim 7, wherein in the sampling of the input PWM signal, a sampling number of the input PWM signal during one period is counted based on the frequency of the internal clock signal.

9. The motor controlling method of claim 7, wherein in the sensing of the change in the speed, it is determined that the speed of the internal clock signal has decreased when a sampling number of the input PWM signal during one period decreases, while it is determined that the speed of the internal clock signal has increased when the sampling number of the input PWM signal during one period increases.

10. The motor controlling method of claim 9, further comprising controlling a rotation speed of the motor from the sensed change in the speed.
